(19) United States
(12) Patent Application Publication
(10) Pub. No.: US 2018/0169988 A1
(43) Pub. Date: Jun. 21, 2018

(54) CARTON FORMING MACHINE AND RELATED METHODS

(71) Applicant: KLIKLOK CORPORATION, Decatur, GA (US)

(72) Inventors: Charles C. Somers, III, Lilburn, GA (US); Charles Holton Vaughn, Grayson, GA (US)

(21) Appl. No.: 15/512,669

(22) PCT Filed: Sep. 18, 2015
(86) PCT No.: PCT/US15/50974

§ 371 Date: Mar. 20, 2017

Related U.S. Application Data
(60) Provisional application No. 62/052,902, filed on Sep. 19, 2014.

(51) Int. Cl. B31B 50/00; B31B 50/06; B31B 50/80; B31B 50/02; B31B 50/04

(52) U.S. Cl. CPC B31B 50/0012; B31B 50/06; B31B 2110/35; B31B 50/022; B31B 50/042; B31B 50/80

(57) ABSTRACT

A machine for forming a carton from a carton blank using a forming cavity uses at least one gripper for gripping and transporting the carton blank toward the forming cavity along a path of travel (such as from the hopper to a transporter in a linear fashion). A plurality of grippers may be provided for gripping and transporting the carton blank toward the forming cavity along the path of travel. The or each gripper may be adapted for gripping a lateral side of the carton blank, and the gripper(s) may be connected to a transporter adapted for moving in a reciprocal fashion along a linear path of travel. The machine may also include a forming cavity adapted for being raised and lowered, as well as a low level hopper for holding the carton blanks such that each is raised to associate with the gripper(s). Related methods are also disclosed.

This application claims the benefit of U.S. Provisional Patent Application Ser. No. 62/052,902, the disclosure of which is incorporated herein by reference.

### FIELD OF THE INVENTION

This disclosure relates to the carton forming arts and, more particularly, to a machine for forming a carton from a blank.

### BACKGROUND OF THE INVENTION

Machines for feeding carton blanks and then forming a carton from the blank for subsequent processing (such as closing of the lid) are well known. Versions of such machines, often called “shuttle formers,” can suffer from certain limitations, especially when the carton blanks are oversized. For one, a hopper provided for holding the carton blanks is generally positioned above the mechanism for conveying the blanks to a forming cavity (which is usually at a discharge height of about 34 inches to accommodate a takeaway conveyor). This can make it difficult to load the hopper, which difficulty is exacerbated with larger, heavier carton blanks. A similar problem may result from the fact that, to achieve the desired low discharge height with large cartons, the height of the forming cavity may be above a level easily accessible by a person standing on the ground.

Another limitation is that many machines use lugs to convey the carton blank to the forming station. This type of conveyance by pushing results in a lack of positive registration of the carton blank while it is conveyed. This can lead to buckling or skewing and concomitant mis-forming at best, and potentially a catastrophic event if a jam occurs as a result of a misfed blank.

Accordingly, a need exists for an improved carton feeding and forming machine for overcoming the foregoing limitations and others. In particular, a need is identified for a carton forming machine that overcomes the problem of mis-registration as a result of the uncontrolled conveyance of a carton blank to a forming cavity. A further need is identified for a carton forming machine that accommodates loading and adjustment by a person of regular height standing on the ground, which is especially useful for oversized carton blanks.

### SUMMARY

According to one aspect of the disclosure, a machine is provided for forming a carton from a carton blank using a forming cavity. The machine may include at least one retainer for retaining the carton blank. The machine may further include a transporter for transporting the carton blank toward the forming cavity along a linear path of travel. The retainer may be connected to the transporter such that the two structures move in concert.

In one embodiment, the retainer comprises a gripper. One or more such grippers may be provided for gripping the carton blank, such as along a lateral side thereof. In one possible embodiment, the gripper or grippers comprise spaced jaws adapted for moving along both the path of travel with the transporter and in a direction transverse to the path of travel for engaging the carton blank. The spaced jaws thus positively contact different (upper and lower) sides in the carton blank during conveyance.

The transporter may be adapted for moving in a reciprocating (reciprocal) fashion along the path of travel. This reciprocal movement may be achieved using an endless belt connected to the transporter and driven by a reversible motor. The transporter may also have an adjustable stroke along the path of travel for accommodating different sizes of carton blanks.

A hopper may be adapted for supporting a plurality of carton blanks, such as for being selected by a feeder for delivery to the retainer or gripper, which again may work in concert with the transporter (which need not take any particular form). The hopper may be positioned such that each carton blank is selected by a feeder and raised to associate with the transporter. The hopper may be arranged such that an upper portion of the hopper intersects a generally horizontal plane coextensive with the path of travel of the transporter. The hopper may orient the carton blanks in a generally vertical direction, and the feeder may rotate each blank to a generally horizontal direction for being retained by the retainer. The hopper may be adapted for raising and lowering the plurality of carton blanks.

A support may also be provided for the forming cavity. The support may be adapted for being raised and lowered, such as relative to a frame forming a part of the machine. The support may also provide support for the transporter for transporting the carton blanks to the forming cavity.

The transporter may also include one or more registers for registering the position of the carton blank during conveyance along the path of travel. The one or more registers may register the position of the blank in a travel direction or a direction transverse to the travel direction. The transporter may also include first and second spaced side portions forming an opening for receiving the blank.

A further aspect of the disclosure pertains to a machine for forming a carton from a carton blank fed by a feeder for delivery to a forming cavity. The machine comprises a former including a forming cavity, and a support for the forming cavity adapted for being raised and lowered. The machine may further include a transporter for transporting the carton blank delivered by the feeder to the forming cavity, which transporter may be supported by the support. The support may be mounted for pivoting movement such that a front end of the support is at or below an operator's height. The machine may further include a hopper positioned at or below an operator's height.

According to a further aspect of the disclosure, a machine for forming a carton from a carton blank fed by a feeder for delivery to a forming cavity. The machine comprises a transporter for receiving the carton blank from the feeder and transporting the carton blank to the forming cavity along a path of travel. A hopper is also provided, which may be adapted for supporting a plurality of carton blanks. The hopper is arranged such that an upper portion of the hopper intersects a generally horizontal plane coextensive with the path of travel of the transporter.

In any embodiment, a device may be provided for applying or activating an adhesive during the movement of the carton blank along the path of travel.

Yet a further aspect of the disclosure pertains to a machine for forming a carton from a carton blank fed by a feeder for delivery to a forming cavity. The machine includes a transporter for receiving the carton blank from the feeder and transporting the carton blank to the forming cavity along a path of travel. The transporter has at least one retainer for retaining the carton blank during conveyance along the path of travel to the forming cavity. A hopper adapted for supporting a plurality of carton blanks is also provided, and is arranged such that a majority of the hopper is below a generally horizontal plane coextensive with the path of travel of the carton blank.

A further aspect of the disclosure pertains to a method of forming a carton from a carton blank delivered from a hopper by a feeder for delivery to a forming cavity along a path of travel. The method comprises retaining the carton blank during conveyance along the path of travel using a retainer traveling along the path of travel.

Still a further aspect of the disclosure a method of forming a carton from a carton blank delivered from a hopper by a feeder for delivery to a forming cavity along a path of travel. The method comprises gripping the carton blank during conveyance to the forming cavity. The gripping step may comprise gripping the carton blank upon being fed by the feeder and releasing the carton blank prior to the carton blank reaching the forming cavity.

Yet another aspect of the disclosure pertains to a method of forming a carton from a carton blank delivered from a hopper by a feeder for delivery to a forming cavity along a path of travel. The method comprises providing a transporter for transporting the carton blank to the forming cavity. The transporter is arranged for moving in a reciprocal fashion from a first position for receiving the carton blank from the feeder to a second position for being formed by the forming cavity. The method may further include the step of moving the transporter from the second position to the first position while the forming cavity forms the carton from the carton blank. Also, the method may include the step of positively gripping the carton blank during the movement from the first position to the second position, and also adjusting the stroke of the transporter for different carton sizes, or adjusting the position of the hopper for different carton sizes. In any embodiment, the method may include engaging the carton blank adjacent to the forming cavity using a plunger adapted for applying a vacuum to the carton blank, as well as applying or activating an adhesive during the movement of the carton blank along the path of travel.

### BRIEF DESCRIPTION OF THE DRAWING FIGURES

FIG. 1 is a perspective view of a machine according to one embodiment of the disclosure;

FIG. 2 is a side view of the machine of FIG. 1;

FIGS. 3-6 are progressive views showing the pick of the carton blank from a hopper and movement to associate with a gripper/transporter;

FIG. 7 is a top view showing the carton blank being transported along a path of travel to a forming cavity;

FIG. 8 is a top view similar to FIG. 7, but enlarged;

FIG. 9 is a bottom view of the carton blank associated with the transporter;

FIG. 10 is a bottom perspective view of the carton blank associated with the transporter;

FIG. 11 is an end view of the transporter, showing the gripper in a closed condition for positively engaging the carton blank;

FIG. 12 is an enlarged perspective view of the machine of FIG. 1; and

FIG. 13 is a top diagrammatic view of a transporter illustrating the variable stroke.

### DESCRIPTION OF THE INVENTION

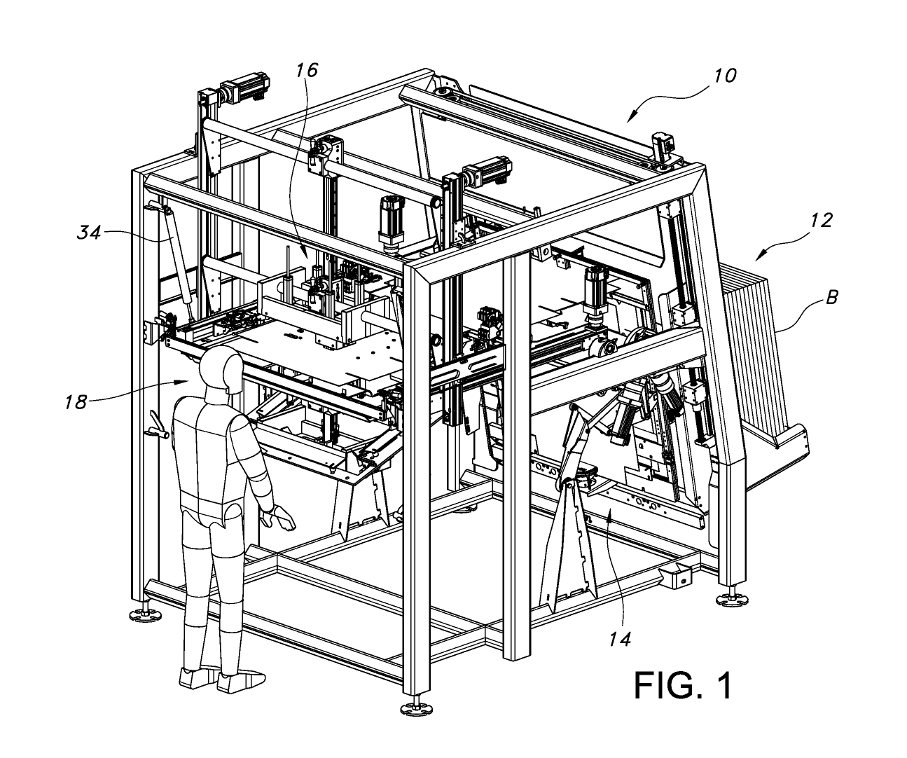

Reference is now made to FIG. 1, showing an overall perspective view of one embodiment of a carton forming machine 10. In the illustrated embodiment, the machine 10 includes a hopper 12 for holding a plurality of carton blanks B. A feeder 14 is provided for selecting a single blank and delivering it to a transporter 16, which then conveys the carton blank B to a former 18 for forming the blank into a carton. The carton may then be delivered (ejected downwardly) to a takeaway conveyor (not shown), usually with a lid portion remaining in an open condition. The interaction and operation of these components of the machine 10 will be outlined in detail in the following description.

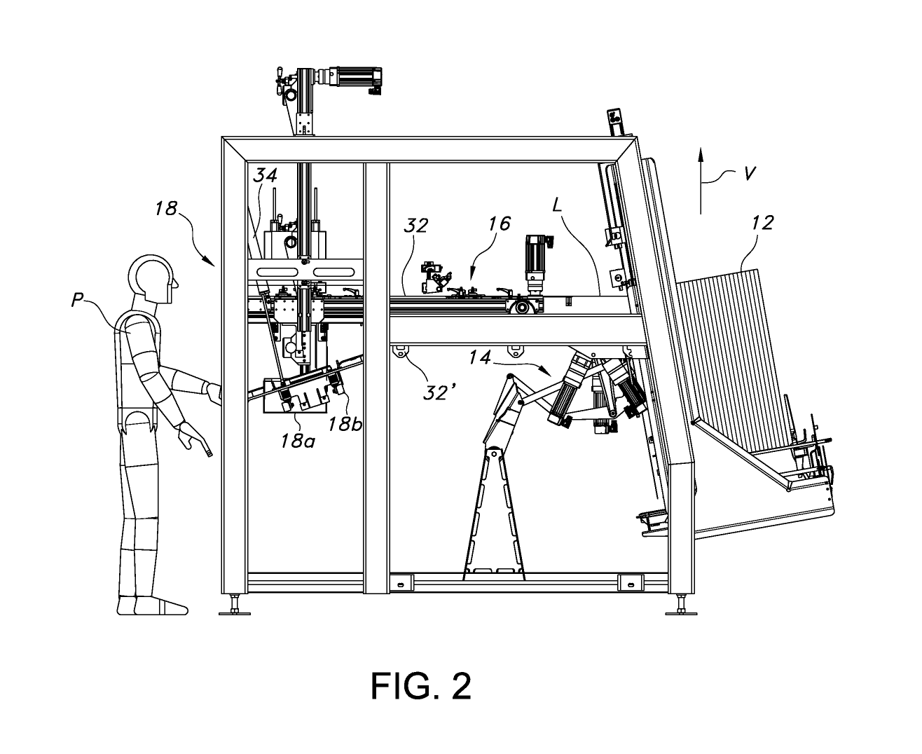

Turning first to the hopper 12, it is arranged to hold the blanks B in a generally vertical orientation, as can be understood with reference to FIG. 1. In the illustrated embodiment, the orientation is approximately 80 degrees from a plane perpendicular with the ground, or 10 degrees from normal. This can be best understood with reference to the side view of FIG. 2 (note vertical direction V), which also shows that the hopper 12 is provided at a location easily accessible to a person P of standard height. In particular, a major portion of the hopper 12 (and, in particular, the entirety of the end associated with the picking of the next-in-line blank B by the the feeder 14) is provided below a level L corresponding to a generally horizontal plane of the transporter 16, which provides for ease of loading. Consequently, in the illustrated embodiment, the level L intersects an upper portion of the hopper.

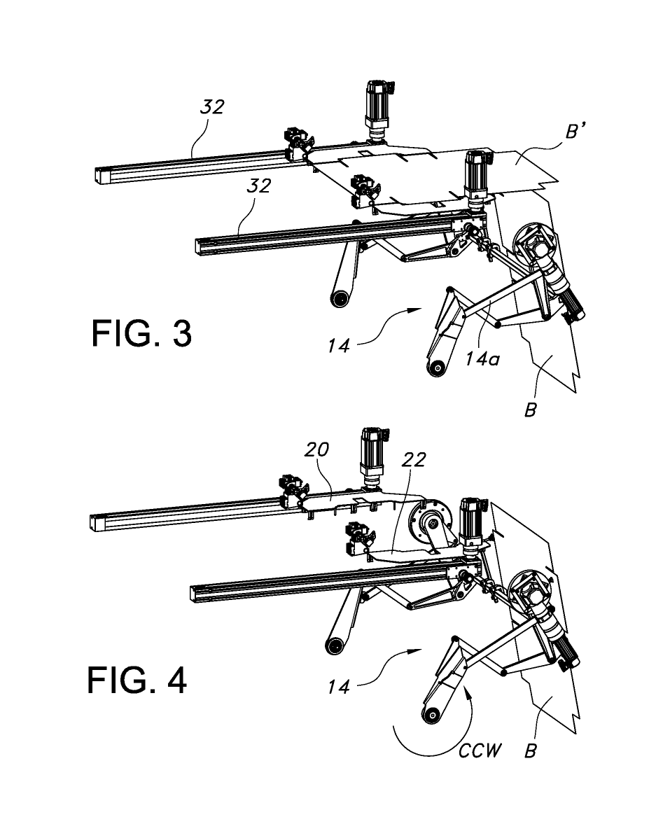

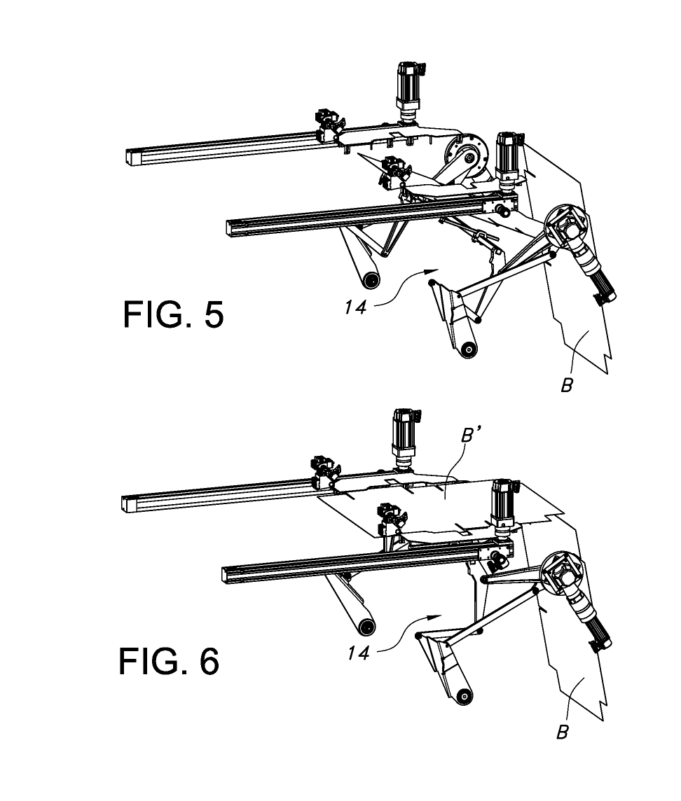

The feeder 14 is arranged to select a single blank B from the hopper 12 and move it from the home orientation to a generally horizontal position. As can perhaps be best understood with reference to FIGS. 3-6, the feeder 14 may comprise a linkage 14a fitted with one or more devices (e.g., suction cups 14d; see FIG. 10) for temporarily attaching to the blank B in order to move it to a position for conveyance to a feeding cavity 18b of the former 18. In the illustrated sequence, it can be appreciated that the movement transfers each blank B from the generally vertical, but lower “home” orientation, to a generally horizontal, higher orientation (B′) for conveyance away to the downstream forming cavity 18b. Hence, the movement of the blank B from the hopper 12 is counterclockwise (note arrow CCW) in FIG. 4 from the near-vertical orientation to the horizontal position (compare FIG. 6).

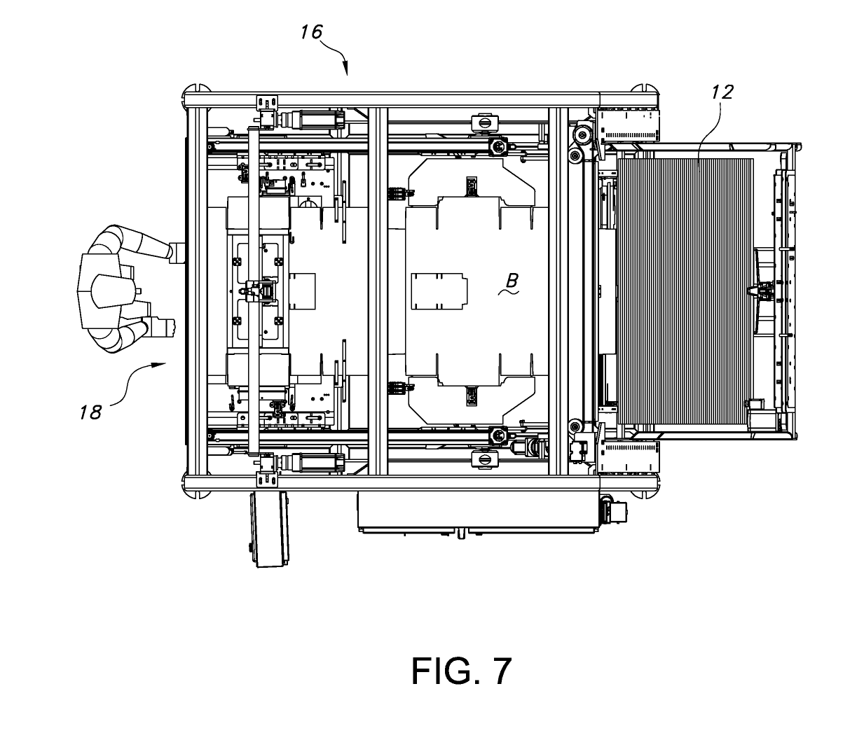

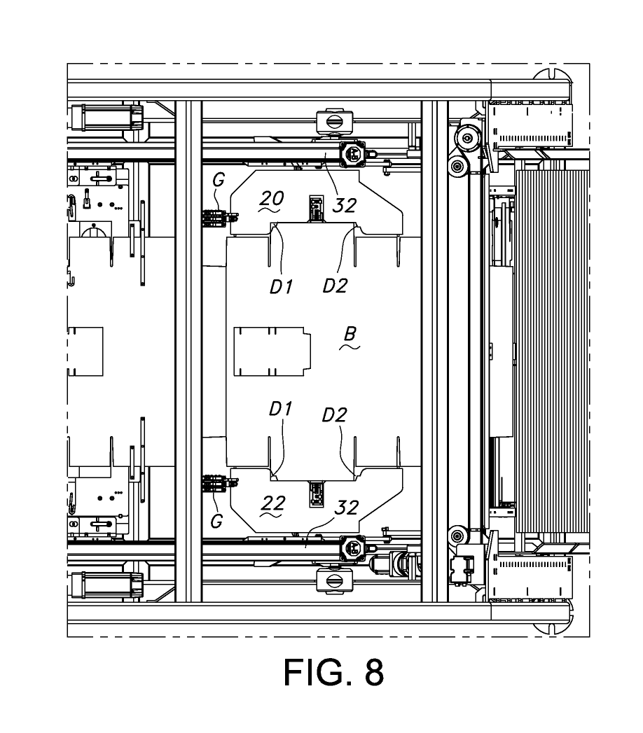

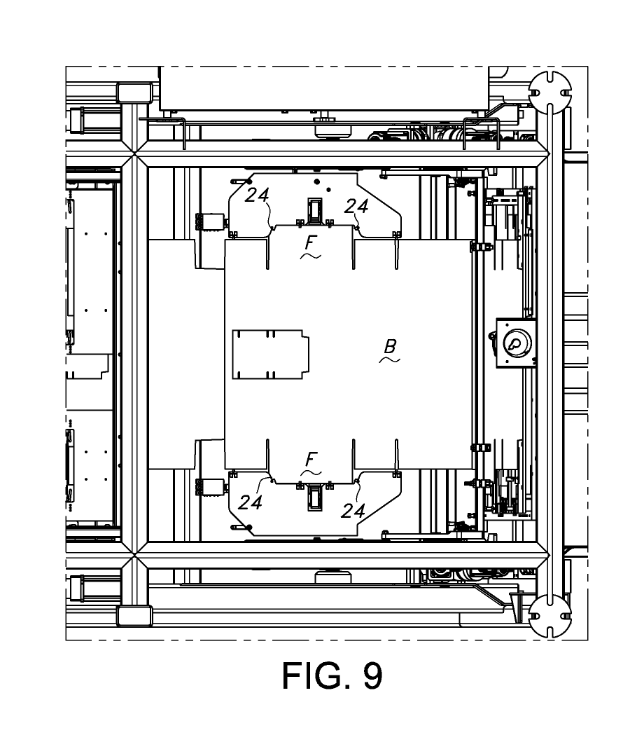

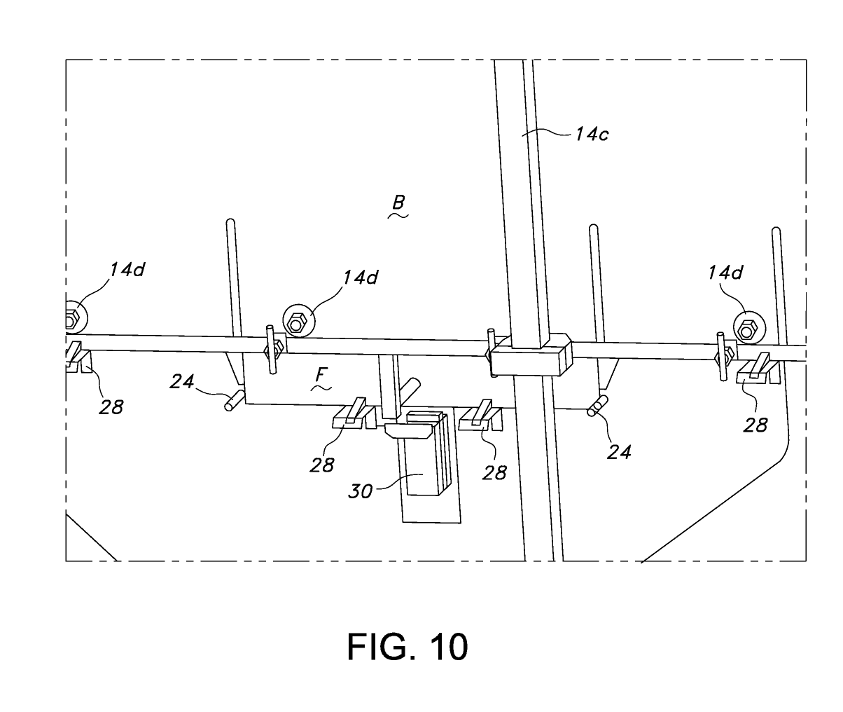

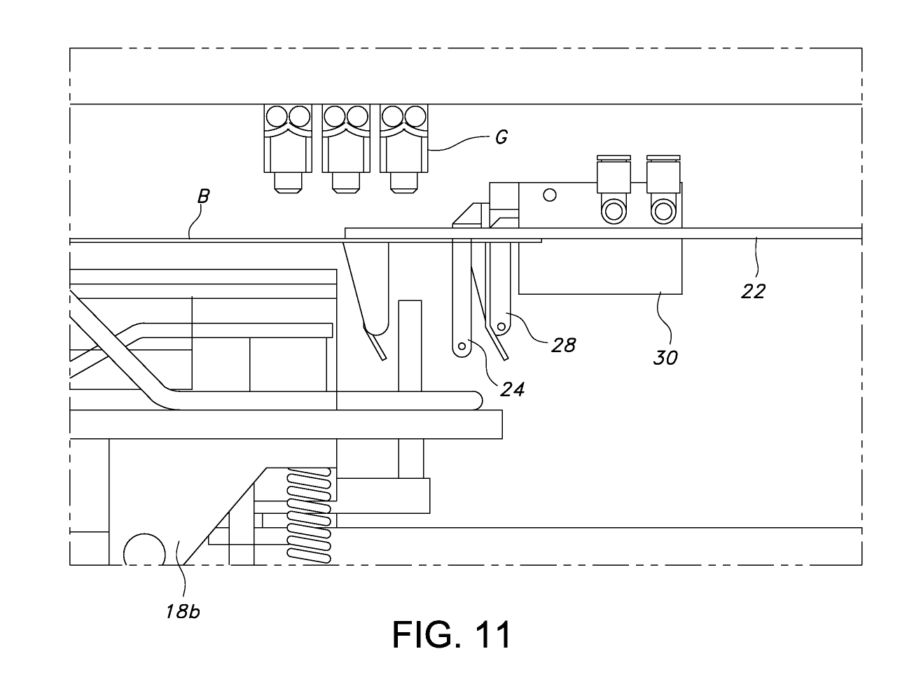

From the horizontal position, the blank B is transported linearly to the forming cavity 18b via a transporter 16. With reference to FIGS. 7-11, it can be understood that the transporter 16 comprises opposed side portions 20, 22 provided on either side of an opening for receiving the blank B from the feeder 14. As can perhaps be best understood with reference to FIGS. 8, 9 and 10, registers, such as pins 24, are provided on the side portions 20, 22. These pins 24 provide passive retention and ensure that the blank B is properly registered in position for conveyance to the forming cavity 18b (see the end view of FIG. 11). In the illustrated embodiment, the registration pins 24 are arranged to engage an extended side flap F of the carton blank B, the advantage of which will be understood from the following description. Optional traps 28 may also provide an additional measure of passive retention in the vertical direction V, which may be especially desirable for heavy blanks to help prevent sagging.

It is also desirable to provide a measure of active retention for the blank B during conveyance. In this regard, each side portion 20, 22 also includes at least one movable retainer, which is a structure that restrains and guides the carton blank (as contrasted with a lug or like structure, which merely pushes the carton blank). In one embodiment, the retainer may comprise a gripper 30 adapted for positively gripping the blank B (such as along the flap F), once in the position (e.g., horizontal) for transport to the forming cavity 18b (and also once the feeder 14 is withdrawn; note the depiction in FIG. 10 of the feeder bar 14c carrying the suction cups 14d for positively attaching to the blank B for rotational conveyance). As can be appreciated, the retainer moves both in a direction corresponding to the conveying direction, as well as in a transverse (vertical) direction.

Each gripper 30 may be arranged so as to have an open condition that allows the carton blank B to pass between the respective jaws, which may then be closed to provide the desired retaining force by contacting opposite side surfaces of the carton blank. As should be appreciated, one of the jaws may remain stationary and the other may move to provide the gripping force, or both jaws may move. The arrangement may be adapted to toggle between the suction force provided by the suction cups 14d and the closing of the jaws of grippers 30 (movement in the vertical direction) to ensure that the blank B is securely held during transport toward the forming cavity 18b, and even in the event of a loss of power or vacuum pressure. Accordingly, one aspect of the invention relates to gripping of the carton blank B at some point during conveyance toward the forming cavity 18b, regardless of the form of transporter used.

With the blank B securely held in place by grippers 30, the side portions 20, 22 of transporter 16 are then advanced along spaced, generally parallel guide tracks 32 (FIG. 8) to deliver the carton blank B to the forming cavity 18b. The movement may be achieved by way of a drive motor, such as a servomotor, which may be associated with an endless timing belt, to achieve a linear and reciprocal profile of movement. Advantageously, the positive registration and gripping during conveyance may prevent the blank B from buckling or skewing, and also provides a measure of lateral support that helps to prevent sagging. Accordingly, the blank B may be delivered to the forming cavity 18b in the proper registered position.

When the forming cavity 18b is reached, the forming process may be achieved as per the conventional practice by which a plunger 18a is used to direct the blank B through the forming cavity 18b, and ultimately deposit it for being carried away for further processing. To help ensure proper registration is maintained, the plunger 18a may optionally be provided with a vacuum capability to establish a positive connection with the blank B upon engagement. As can be appreciated, this helps to ensure that the proper registration is maintained.

With the illustrated embodiment, it should also be appreciated that, since the gripping function is provided along the lateral sides of the blank B, the grippers 30 may be released and the retraction of the transporter 16 to associate with a next-in-line blank fed by the feeder 14 may begin before the forming process is initiated. Advantageously, this may achieve a reduction of the machine cycle time, which may be important if high throughput is desired to keep up with an aggressive downstream operation to meet customer demands.

A further independent advantage of the arrangement is the ability to control the positioning of the blank relative to the transporter 16 by controlling the position of the hopper 12. Specifically, the hopper 12 may be arranged to be selectively raised and lowered as necessary to position different sizes of blanks in association with the transporter 16. In order to ensure consistent treatment, a score line between the bottom and front panel may correspond to a datum D1 in the transporter 16, as may the score line between the bottom and rear panels (datum D2 in FIG. 8). The movement of transporter 16 may be arranged (via servo) to reach a constant velocity after a certain distance of conveyance (e.g., 4 inches) for purposes of reaching an applicator for applying an adhesive (e.g., a glue gun G, see FIGS. 8 and 11), or an activator for activating an already-present adhesive (such as a heat gun). This ensures common treatment regardless of the size of carton blank being accommodated, and helps to ensure that the gluing operation does not degrade as would be caused by an increase in speed.

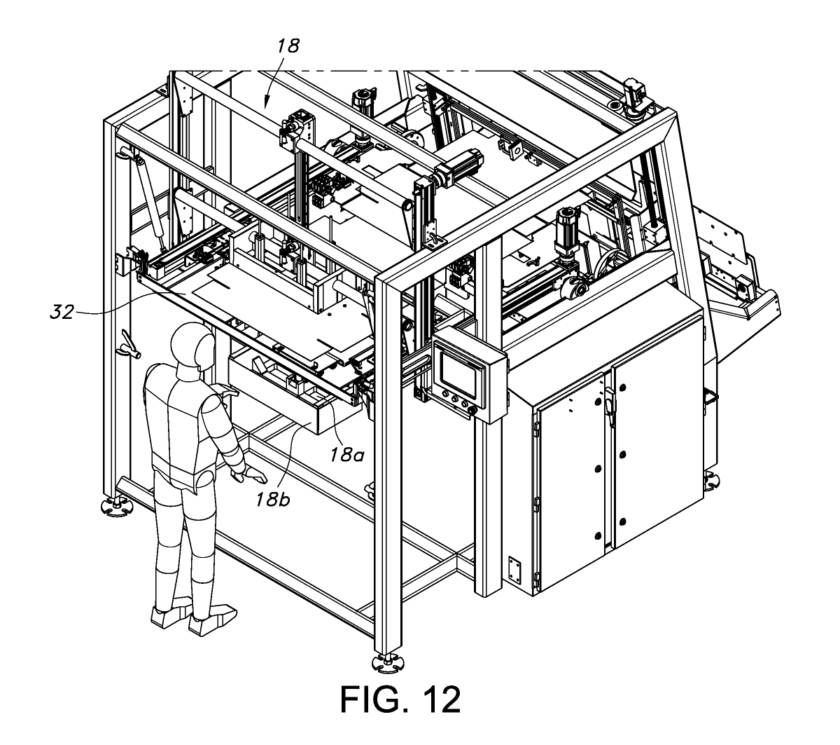

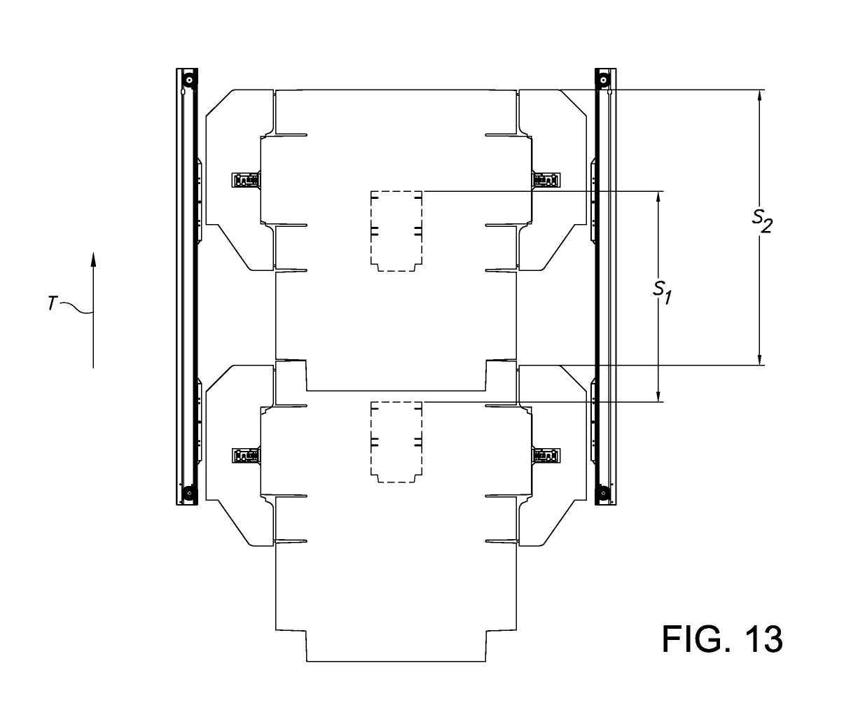

Still a further independent advantage of this arrangement is provided by comparing FIGS. 1, 2, and 12. Specifically, it can be understood that the support 32 supporting the transporter 16 and the forming cavity 18b may be configured to be lowered for access by a person P (compare position 32 in FIG. 2 with position 32′). The support 32 in the illustrated embodiment is mounted for pivoting movement relative to the machine 10 (and frame, in particular) adjacent to the hopper 12. The portion of the support 32 adjacent to the former 18 may be provided with retainers, such as bolts, pins, or the like, for holding the structure in the home (horizontal) position, and for allowing it to be lowered when removed. Optional dampers, such as gas springs 34, may be provided to facilitate the raising and lowering in a smooth, even and controlled manner. As can be appreciated, the plunger 18a may also be controlled by servomotor to allow for selective raising and lowering.

FIG. 13 illustrates that the reciprocation stroke of the transporter 16 may be altered based on the size (length) of the carton blank in the travel direction T. For example, the stroke may be greater for a longer carton blank (S1), and less for a shorter carton (S2) blank. Adjustments to the stroke distance can also be made to ensure that proper registration is achieved in highly reliable, repeatable manner.

The foregoing description has been presented for purposes of illustration. It is not intended to be exhaustive or to limiting. The embodiments described provide an illustration of the inventive principles and the practical application thereof sufficient to enable one of ordinary skill in the art to utilize them in various other embodiments and with various modifications, as are suited to the particular use contemplated. For example, while a single forming head is illustrated, the machine may be used with a plurality of forming heads (e.g., two or three), with different transporters acting in concert for each head, or a single transporter for carrying multiple blanks. Furthermore, while the use of adhesives or glue guns is mentioned, it should be appreciated that the disclosed machine and methods may work suitably with locking-style cartons. All such modifications and variations are within the scope of the invention as determined by the appended claims when interpreted in accordance with the breadth to which they are fairly, legally and equitably entitled.

1. A machine for forming a carton from a carton blank using a forming cavity, comprising:
at least one gripper for gripping the carton blank; and
a transporter for transporting the carton blank toward the forming cavity along a linear path of travel.

2. The machine of claim 1, further including a plurality of grippers for gripping the carton blank.

3. The machine of claim 1, wherein the or each gripper is adapted for gripping a lateral side of the carton blank.

4. The machine of claim 1, wherein the or each gripper is connected to the transporter.

5. The machine according to claim 1, wherein the or each gripper comprises spaced jaws.

6. A machine for forming a carton from a carton blank using a forming cavity, comprising:
a transporter for transporting the carton blank to the forming cavity along a linear path of travel, the transporter including at least one retainer for retaining the carton blank during conveyance along the path of travel to the forming cavity.

7. The machine according to claim 6, wherein the retainer comprises a gripper for gripping each lateral side of the carton blank.

8. The machine according to claim 6, wherein the retainer is adapted for moving in a transverse direction for engaging the carton blank.

9. The machine of claim 1, wherein the transporter is adapted for moving in a reciprocal fashion along the path of travel.

10. The machine of claim 9, wherein the reciprocal movement is achieved using an endless belt connected to the transporter and driven by a reversible motor.

11. The machine of claim 1, wherein the transporter has an adjustable stroke along the path of travel for accommodating different sizes of carton blanks.

12. A machine for forming a carton from a carton blank for delivery to a forming cavity, comprising:
a transporter for transporting the carton blank to the forming cavity, the transporter being arranged for moving in a reciprocal fashion along a linear path of travel from a first position for receiving the carton blank to a second position for being formed by the forming cavity.

13. The machine of claim 12, wherein the reciprocal movement is achieved using an endless belt connected to the transporter and driven by a reversible motor.

14. The machine of claim 12, wherein the transporter has an adjustable stroke along the path of travel for accommodating different sizes of carton blanks.

15. (canceled)

16. The machine according to claim 1, further including a hopper adapted for supporting a plurality of carton blanks.

17. The machine according to claim 16, wherein the hopper is positioned such that each carton blank is selected by a feeder and raised to associate with the transporter.

18. The machine according to claim 16, wherein the hopper is arranged such that an upper portion of the hopper intersects a generally horizontal plane coextensive with the path of travel of the transporter.

19. The machine according to claim 16, wherein the hopper orients the blanks in a generally vertical direction, and the feeder rotates each blank to a generally horizontal direction for being retained by the retainer.

20. The machine according to claim 16, wherein the hopper is adapted for raising and lowering the plurality of carton blanks.

21. The machine according to claim 16, further comprising a support for supporting the forming cavity, the support adapted for being raised and lowered.

22. The machine according to claim 21, wherein the support also supports the transporter.

23. The machine according to claim 1, wherein the transporter includes one or more registers for registering the position of the carton blank during conveyance along the path of travel.

24. The machine according to claim 23, wherein the one or more registers register the position of the blank in a travel direction or a direction transverse to the travel direction.

25. The machine according to claim 1, wherein the transporter includes first and second spaced side portions forming an opening for receiving the blank.

26-45. (canceled)
